(19) United States
(12) Patent Application Publication
(10) Pub. No.: US 2013/0259015 A1
(43) Pub. Date: Oct. 3, 2013

(54) CONTROL METHOD OF WIRELESS COMMUNICATING SYSTEM, WIRELESS BASE STATION, WIRELESS TERMINAL, AND WIRELESS COMMUNICATING SYSTEM

(71) Applicant: FUJITSU LIMITED, Kawasaki-shi (JP)

(72) Inventors: Hiroyuki FUJII, Kawasaki (JP); Ryota SHINOJIMA, Kawasaki (JP)

(21) Appl. No.: 13/673,226

(22) Filed: Nov. 9, 2012

(30) Foreign Application Priority Data
Mar. 28, 2012 (JP) 2012-073169

(51) Int. Cl. H04W 84/18

(52) U.S. Cl. CPC H04W 84/18
USPC 370/338

(57) ABSTRACT

A wireless communicating system includes a plurality of wireless terminals having an Ad-hoc communication function and a wireless base station. The wireless base station allows one of the plurality of wireless terminals which requests the same data to a local station to directly receive the data from the local station and allows the other wireless terminal among a plurality of wireless terminals to receive the data from the one wireless terminal by the Ad-hoc communication function of the one wireless terminal.

### CROSS-REFERENCE TO RELATED APPLICATION

This application is based upon and claims the benefit of priority of the prior Japanese Patent Application No. 2012-073169, filed on Mar. 28, 2012, the entire contents of which are incorporated herein by reference.

### FIELD

The embodiments discussed herein are directed to a control method of a wireless communicating system, a wireless base station, a wireless terminal, and a wireless communicating system.

### BACKGROUND

Recently, with the accompaniment of high functionality and high speed of a wireless terminal, a rich contents market that performs a larger capacity of data communication by a high quality motion picture or a software update file has expanded and an amount of data communication in a wireless communicating system is being increased.

Further, in a wireless communicating system by which a user receives a desired service at a preferable time in a preferable location, a large capacity of data communication is performed all over the place, which also causes the increase in the amount of data communication in the wireless communicating system.

For example, it is expected that the amount of data communication in the wireless communicating system in 2015 will be approximately twenty times larger than 2012, and the amount in 2020 will be approximately 200 times larger than 2012.

Therefore, various studies in order to reduce the amount of data communication in the wireless communicating system have been conducted.

Further, the following patent literature 1 discloses a method that a parent device that stores additional downloaded data searches additional data in accordance with the progress status of a game in a child device and transmits the additional data to the child device so that the child device which cannot be connected to a server may obtain the additional data.
Patent Literature 1: Japanese Laid-open Patent Publication No. 2008-237648

### SUMMARY

(1) As a first suggestion, for example, a control method of a wireless communicating system having a plurality of wireless terminals having an Ad-hoc communication function and a wireless base station which is capable of communicating with the plurality of wireless terminals may be used. The wireless base station allows one of the plurality of wireless terminals which requests the same data to a local station to directly receive the data from the local station, and allows the other wireless terminals among the plurality of wireless terminals to receive the data from the one wireless terminal by the Ad-hoc communication function of the one wireless terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an example of a configuration of a wireless communicating system according to an embodiment;

FIG. 2 is a view illustrating an example of a configuration of a UE illustrated in FIG. 1;

FIG. 3 is a view illustrating an example of a configuration of an eNB illustrated in FIG. 1;

FIG. 4 is a view illustrating an example of a configuration of an MME illustrated in FIG. 1;

FIG. 5 is a view illustrating an example of a communicating control method according to the embodiment;

FIG. 6 is a view illustrating an example of a communicating control method according to the embodiment;

FIG. 7 is a view illustrating an example of a communicating control method according to the embodiment;

FIG. 8 is a view illustrating an example of a communicating control method according to the embodiment;

FIG. 9 is a view illustrating an example of an operation of the eNB;

FIG. 10 is a view illustrating an example of a communicating control method according to the embodiment;

FIG. 11 is a view illustrating an example of a communicating control method according to a first modified embodiment;

FIG. 12 is a view illustrating an example of a communicating control method according to the first modified embodiment;

FIG. 13 is a view illustrating an example of a communicating control method according to a second modified embodiment;

FIG. 14 is a view illustrating an example of a communicating control method according to the second modified embodiment;

FIG. 15 is a view illustrating an example of a communicating control method according to a third modified embodiment;

FIG. 16 is a view illustrating an example of a communicating control method according to the third modified embodiment;

FIG. 17 is a view illustrating an example of a communicating control method according to the third modified embodiment;

FIG. 18 is a view illustrating an example of a hardware configuration of a UE;

FIG. 19 is a view illustrating an example of a hardware configuration of an eNB; and

FIG. 20 is a view illustrating an example of a hardware configuration of an MME.

### DESCRIPTION OF EMBODIMENTS

Hereinafter, embodiments of the present invention will be described with reference to the drawings. However, the embodiments which will be described below are illustrative only and it is not intended to exclude the application of various modifications and technologies which are not described in the present embodiment. In other words, various modifications of embodiments and modified embodiments which will be described below may be made without departing from the spirit of the invention.

### [1] Embodiment

### (1.1) Example of Configuration of Wireless Communicating System

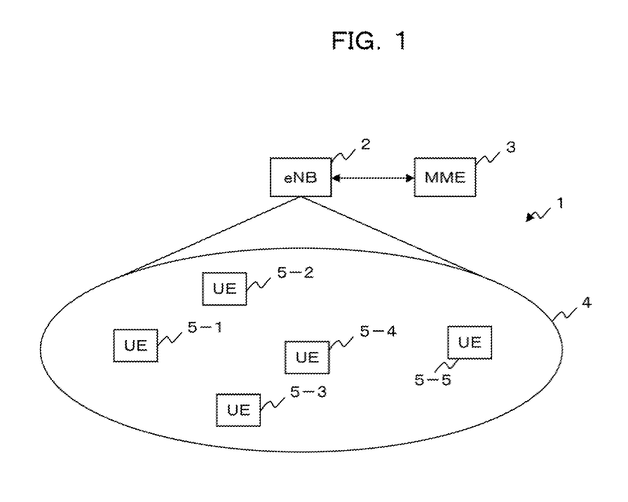

FIG. 1 is a view illustrating an example of a configuration of a wireless communicating system according to an embodiment.

The wireless communicating system 1 illustrated in FIG. 1 illustratively includes a wireless base station (eNB: eNodeB) 2, an MME (mobility management entity) 3, and a plurality of wireless terminals (UE: user equipment) 5-1 to 5-5. Hereinafter, when it is unnecessary to distinguish the UEs 5-1 to 5-5, the UEs are simply represented as a UE 5. Further, the number of UEs 5 is not limited to the number illustrated in FIG. 1.

The eNB 2 may wirelessly communicate directly with the UE 5 which is located in a range of a wireless area 4 such as a cell or sector provided by a local station 2. Further, the eNB 2 may wirelessly communicate indirectly even with a UE 5 which is located outside the wireless area 4 through a relay device such as a repeater. The eNB 2 may communicate with other eNB 2 through a core network (not illustrated).

Further, the eNB 2 may transmit/receive various information concerning the UE 5 to/from the MME 3.

The MME 3 manages various information concerning the UE 5, and, for example, has functions that manage location registration, call, or handover of the UE 5.

The UE 5 may wirelessly transmit/receive data to/from the eNB 2 which is a source of the wireless area 4 where the local station 5 is located. Further, the UE 5 may communicate with the eNB 2 through the relay device such as a repeater.

However, the UE 5 of the embodiment has a function that wirelessly communicates directly with other UE 5. Hereinafter, the communication is simply referred to as terminal-to-terminal communication (Ad-hoc communication) in some cases.

That is, the UE 5, for example, has a function that directly transmits/receives data to/from other UE 5 which is located in a certain range from the local station 5 without using the eNB 2 or the core network. Further, the UE 5 performs the terminal-to-terminal communication with another UE 5 which is connected to the eNB 2 or the core network to connect another UE 5 to the eNB 2 or the core network as an external modem, which is referred to as tethering.

### (1.2) Example of Configuration of UE 5

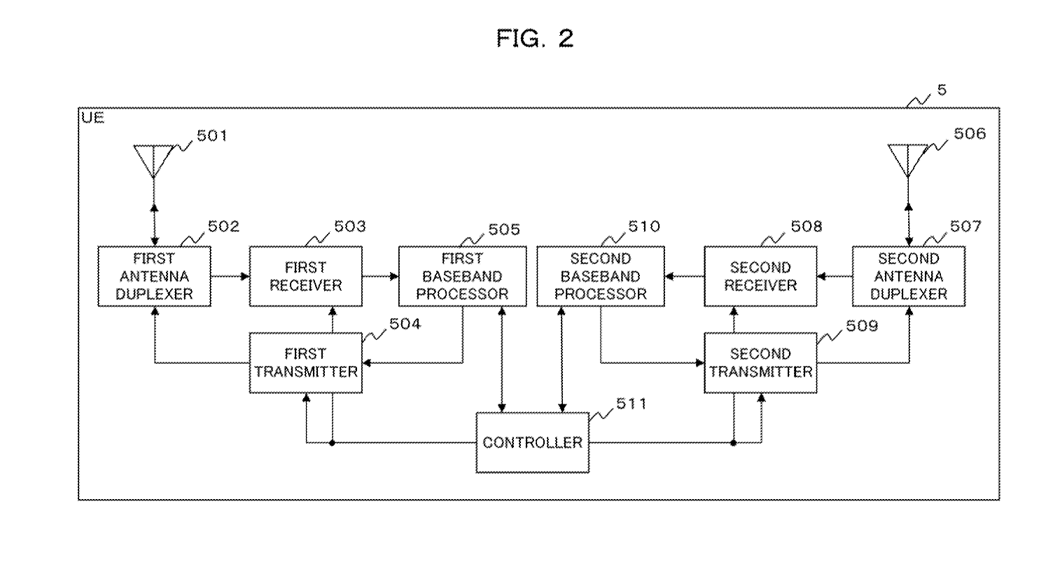

FIG. 2 is a view illustrating an example of a configuration of the UE 5.

The UE 5 illustrated in FIG. 2, illustratively, includes an antenna 501, a first antenna duplexer 502, a first receiver 503, a first transmitter 504, and a first baseband processor 505. Further, the UE 5 illustrated in FIG. 2, illustratively, includes an antenna 506, a second antenna duplexer 507, a second receiver 508, a second transmitter 509, a second baseband processor 510, and a controller 511.

The antenna 501 transmits/receives a wireless signal to/from an eNB 2 included in an LTE (long term evolution) wireless communicating system 1 or a BTS (base transceiver station) included in a 3G (3rd generation) wireless communicating system.

The first antenna duplexer 502 is a device that switches a transmitting/receiving function of the antenna 501. Further, when the UE 5 separately includes a transmitting antenna and a receiving antenna instead of the antenna 501, the first antenna duplexer 502 may be omitted.

The first receiver 503 performs a certain wireless reception processing on the wireless signal received by the antenna 501. The wireless reception processing, for example, includes processings such as low-noise amplification, frequency conversion to a baseband frequency (down conversion), or A/D (analog/digital) conversion of a received wireless signal.

The first transmitter 504 performs a certain wireless transmission processing on the wireless signal transmitted by the antenna 501. The wireless transmission processing, for example, includes processings such as D/A (digital/analog) conversion, frequency conversion to a radio frequency (up conversion), or power amplification of transmission data.

The first baseband processor 505 performs the baseband processing with respect to the wireless reception processing result in the first receiver 503 and performs the baseband processing with respect to the transmission data on which the wireless transmission processing is performed in the first transmitter 504.

In the meantime, the antenna 506 directly transmits/receives (that is, terminal-to-terminal communication) the wireless signal to/from another UE 5 which is located in a certain range from the local station 5. The terminal-to-terminal communication, for example, may be implemented by using a standard of a near field wireless communication such as Wi-Fi (registered trademark) or Bluetooth (registered trademark).

The second antenna duplexer 507 is a device that switches a transmitting/receiving function of the antenna 506. Further, when the UE 5 separately includes a transmitting antenna and a receiving antenna instead of the antenna 506, the second antenna duplexer 507 may be omitted.

The second receiver 508 performs a certain wireless reception processing on the wireless signal received by the antenna 506. The wireless reception processing, for example, includes processings such as low-noise amplification, frequency conversion to a baseband frequency (down conversion), or A/D (analog/digital) conversion of a received wireless signal.

The second transmitter 509 performs a certain wireless transmission processing on the wireless signal transmitted by the antenna 506. The wireless transmission processing, for example, includes processings such as D/A (digital/analog) conversion, frequency conversion to a radio frequency (up conversion), or power amplification of transmission data.

The second baseband processor 510 performs the baseband processing with respect to the wireless reception processing result in the second receiver 508 and performs the baseband processing with respect to the transmission data on which the wireless transmission processing is performed in the second transmitter 509.

The controller 511 controls operations of the first receiver 503, the first transmitter 504, the first baseband processor 505, the second receiver 508, the second transmitter 509, and the second baseband processor 510. Further, the controller 511 may generate transmission data which is transmitted from the antennas 501 and 506 and provide reception data received by the antennas 501 and 506 to various application processors (not illustrated).

In other words, the first transmitter 504 serves as an example of a base station side transmitter that transmits a data request to the eNB 2, the first receiver 503 serves as an example of a base station side receiver that directly receives data corresponding to the data request transmitted by the first transmitter 504 from the eNB 2.

The second transmitter 509 serves as an example of a terminal side transmitter that directly transmits the data received by the first receiver 503 to another UE 5 by an Ad-hoc communication function and the second receiver 508 serves as an example of a terminal side receiver that directly receives data corresponding to the data request transmitted by the first transmitter 504 from another UE 5 by the Ad-hoc communication function.

### (1.3) Example of Configuration of eNB 2

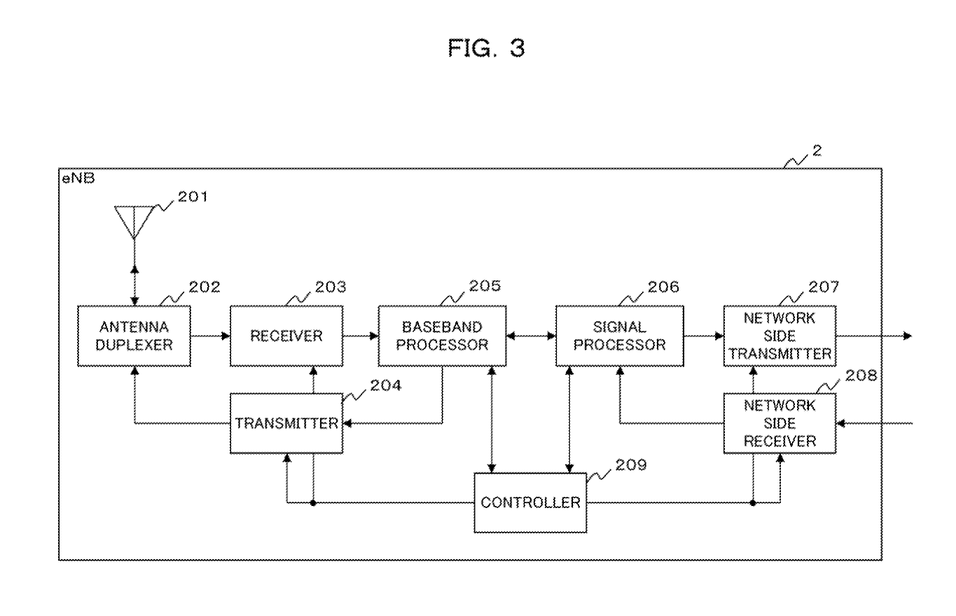

FIG. 3 is a view illustrating an example of a configuration of the eNB 2.

The eNB 2 illustrated in FIG. 3, illustratively, includes an antenna 201, an antenna duplexer 202, a receiver 203, a transmitter 204, and a baseband processor 205. Further, the eNB 2 illustrated in FIG. 3, illustratively, includes a signal processor 206, a network side transmitter 207, a network side receiver 208, and a controller 209.

The antenna 201 transmits/receives a wireless signal to/from a UE 5 which is located in the wireless area 4 provided by the local station 2. Further, the antenna 201 may indirectly transmit/receive a wireless signal to/from a UE 5 which is located outside the wireless area 4 provided by the local station 2 through a repeater that relays the wireless signal.

The antenna duplexer 202 is a device that switches a transmitting/receiving function of the antenna 201. Further, when the eNB 2 separately includes a transmitting antenna and a receiving antenna instead of the antenna 201, the antenna duplexer 202 may be omitted.

The receiver 203 performs a certain wireless reception processing on the wireless signal received by the antenna 201. The wireless reception processing, for example, includes processings such as low-noise amplification, frequency conversion to a baseband frequency (down conversion), or A/D (analog/digital) conversion of a received wireless signal.

The transmitter 204 performs a certain wireless transmission processing on the wireless signal transmitted by the antenna 201. The wireless transmission processing, for example, includes processings such as D/A (digital/analog) conversion, frequency conversion to a radio frequency (up conversion), or power amplification of transmission data.

The baseband processor 205 performs the baseband processing with respect to the wireless reception processing result in the receiver 203 and performs the baseband processing with respect to the transmission data on which the wireless transmission processing is performed in the transmitter 204.

In the meantime, the network side receiver 208 has a function that receives data from a device such as an MME 3 disposed at the core network side and the network side transmitter 209 has a function that transmits data to a device such as the MME 3 disposed at the core network side.

The signal processor 206 transmission-channel encodes a data signal from the baseband processor 205 and sends the data signal to the network side transmitter 207. Further, the signal processor 206 decodes the transmission channel signal from the network side receiver 208 and sends the transmission channel signal to the baseband processor 205.

Further, the signal processor 206 transmission-channel encodes a control message generated by the controller 209 and sends the control message to the network side transmitter 207.

The controller 209 controls operations of the receiver 203, the transmitter 204, the baseband processor 205, the signal processor 206, the network side transmitter 207, and the network side receiver 208. Further, the controller 209 may generate transmission data that is transmitted from the antenna 201 and the network side transmitter 207 or various control messages or provide reception data that is received by the antenna 201 and the network side receiver 208 to various application processors (not illustrated).

Specifically, the receiver 203 serves as an example of a receiver that receives the data request from a plurality of UEs 5 and the controller 209 serves as an example of a controller that controls one UE 5 of a plurality of UEs 5 that request the same data to the local station 2 to directly receive the data from the local station 2 and controls the other UEs 5 to receive the data from the one UE 5 by the Ad-hoc communication function of the one UE 5.

### (1.4) Example of Configuration of MME 3

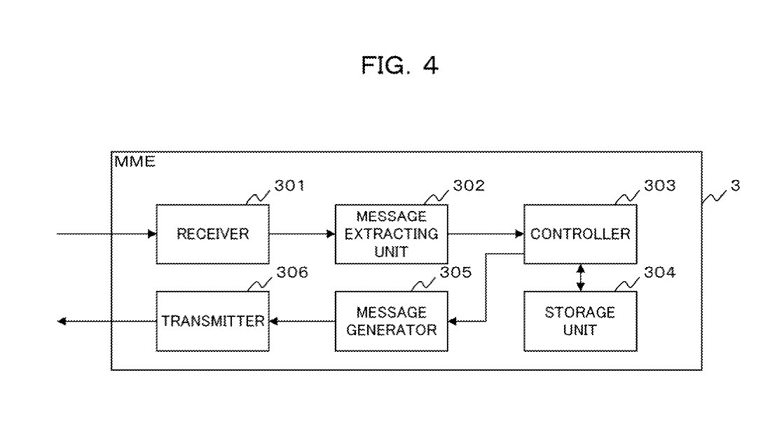

FIG. 4 is a view illustrating an example of a configuration of the MME 3.

The MME 3 illustrated in FIG. 4, illustratively, includes a receiver 301, a message extracting unit 302, a controller 303, a storage unit 304, a message generator 305, and a transmitter 306.

The receiver 301 receives data transmitted from the eNB 2. The data received by the receiver 301 is sent to the message extracting unit 302.

The message extracting unit 302 extracts a control message from the data received by the receiver 301. The control message extracted by the message extracting unit 302 is sent to the controller 303.

The controller 303 searches various data from the storage unit 304 based on the control message extracted by the message extracting unit 302 and delivers the data to the message generator 305.

The message generator 305 generates a control message including the data delivered from the controller 303 and sends the control message to the transmitter 306.

The transmitter 306 transmits the control message generated by the message generator 305 to the eNB 2.

### (1.5) Example of Operation of Wireless Communicating System 1

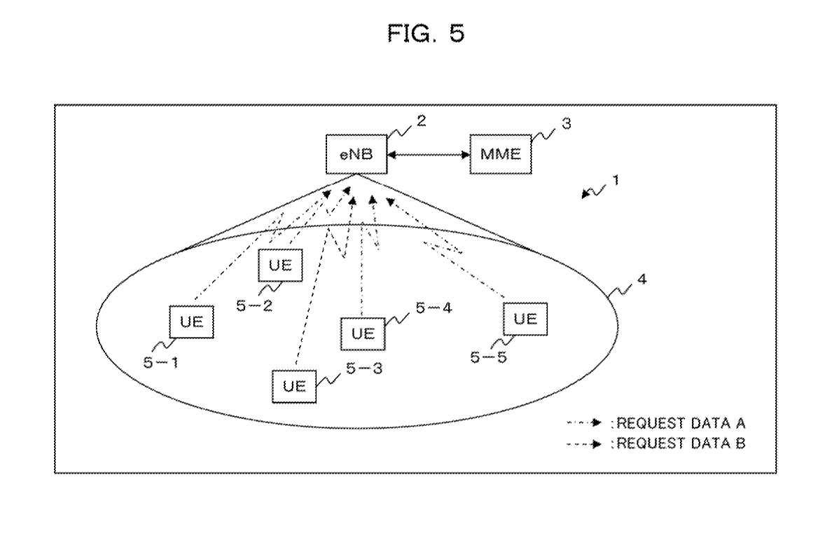

An example of an operation of a wireless communicating system 1 including the UEs 5, the eNB 2, and the MME 3 each having the configuration described above will be described with reference to FIGS. 5 to 7.

First, as illustrated in FIG. 5, each UE 5 requests the eNB 2 to download data.

In this case, the UEs 5-1, 5-2, 5-4, and 5-5 request the eNB 2 to download data A (see dashed-dotted arrow of FIG. 5) and the UE 5-3 requests the eNB 2 to download data B which is different from the data A (see dashed arrow of FIG. 5). The data A and B, for example, include streaming data, an update file for updating software, or a voice or motion picture file having a comparatively large capacity.

Next, the eNB 2 obtains the data A and B which are requested by the UEs 5 through the core network and determines whether there are a plurality of UEs 5 that request the same data based on information concerning the UEs 5 stored in the MME 3 (information concerning an access point of UEs 5). Further, the eNB 2 may determine whether the UEs 5 request the same data based on whether the access points of the UEs 5 are same. Even though the access points of the UEs 5 are different from each other, the eNB 2 may compare the data obtained from the core network to determine whether the UEs 5 request the same data.

Here, in the example illustrated in FIG. 5, since the UEs 5-1, 5-2, 5-4, and 5-5 request the eNB 2 to download the same data A, the eNB 2 determines that there are a plurality of UEs 5 that request the same data (for example, data A).

Next, the eNB 2 confirms the positional relationship of the UEs 5-1, 5-2, 5-4, and 5-5 that request the same data A based on the information concerning the UEs 5 stored in the MME 3 (positional information of the UEs 5).

For example, the eNB 2 determines a UE 5 which is included in a range where the number of UEs 5 which are located in a certain range is maximum as a control target of this embodiment using any one UE 5 of the UEs 5-1, 5-2, 5-4, and 5-5 which request the same data A as an origination.

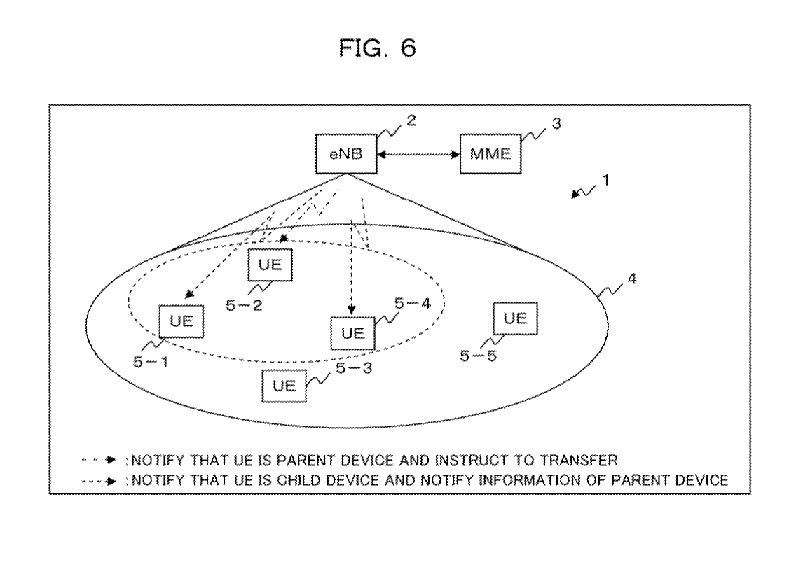

In the example illustrated in FIG. 6, the UEs 5-1, 5-2, and 5-4 which are located in a certain range (see a dashed line ellipse of FIG. 6) among the UEs 5-1, 5-2, 5-4, and 5-5 which request the same data A are determined as a target of the communicating control of this embodiment. Further, the UE 5-5 is spaced apart from any of the UEs 5-1, 5-2, and 5-4 so that the terminal-to-terminal communication is not available. Therefore, it is determined that the UE 5-5 is not the target of the communicating control. Further, the UE 5-3 requests data B which is different from the data A, so that it is determined that the UE 5-3 is not the target of the communicating control.

The eNB 2, as illustrated in FIG. 6, determines at least one of the UEs 5-1, 5-2, and 5-4 which are determined as a control target as a parent device that receives the data A from the eNB 2 and transfers the data A to another UE 5 and determines another UE 5 as a child device that receives the data A from the UE 5 as a parent device by the terminal-to-terminal communication.

In this case, based on the positional information of UEs 5-1 to 5-5, the eNB 2 may select the UE 5 as the parent device so as to maximize the number of the UEs 5 as a child device which is located in a range where the UE 5 as a parent device is capable of communicating by the Ad-hoc communication function. As a result of the selection, in the example illustrated in FIG. 6, the UE 5-2 is determined as a parent device and the UEs 5-1 and 5-4 are determined as a child device.

Further, the eNB 2 notifies the UE 5-2 that the UE 5-2 is determined as a parent device and instructs to transfer the data A transmitted from the eNB 2 to the UEs 5-1 and 5-4 as a child device (see a one-dot chain line arrow of FIG. 6).

In addition, the eNB 2 notifies the UEs 5-1 and 5-4 that the UEs 5-1 and 5-4 are determined as a child device and transmits information concerning the UE 5-2 as the parent device (see a broken lined arrow of FIG. 6). Furthermore, the communication volume such as the notification transmitted to the UEs 5-2, 5-1, and 5-4 is significantly smaller than the communication volume of the data A.

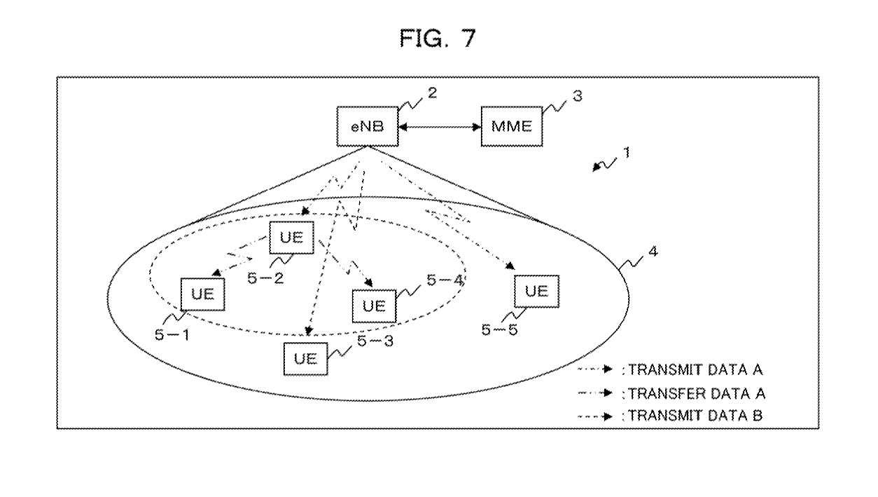

The eNB 2, as illustrated in FIG. 7, instructs the UE 5-2 which is determined as the parent device to continuously communicate with the eNB 2 and to wirelessly transmit the data A obtained from the core network (see a one-dot chain line arrow of FIG. 7).

In the meantime, the eNB 2 stops the communication with the UEs 5-1 and 5-4 which are determined as the child device and allows the UEs 5-1 and 5-4 to obtain data A from the UE 5-2 which is a parent device (see a two-dot chain line arrow of FIG. 7).

Further, the eNB 2 may allow the UE 5-5 which is not a target of the communicating control, among the UEs 5 that request the data A to continuously communicate with the eNB 2 and wirelessly transmit the data A obtained from the core network (see a one-dot chain line arrow of FIG. 7).

In addition, the eNB 2 requests data B which is different from the data A and allows the UE 5-3 which is not the target of the communicating control to continuously communicate with the eNB 2 to wirelessly transmit the data B obtained from the core network (see a broken line arrow of FIG. 7).

As described above, according to this example, among the plurality of UEs 5 that request the same data, the UEs 5-1 and 5-4 as the child device may obtain data from the UE 5-2 as the parent device by the terminal-to-terminal communication without using the eNB 2 or the core network and the communication volume at the network side of the wireless communicating system 1 may be significantly reduced.

### (1.6) Specific Example of Operation of Wireless Communicating System 1

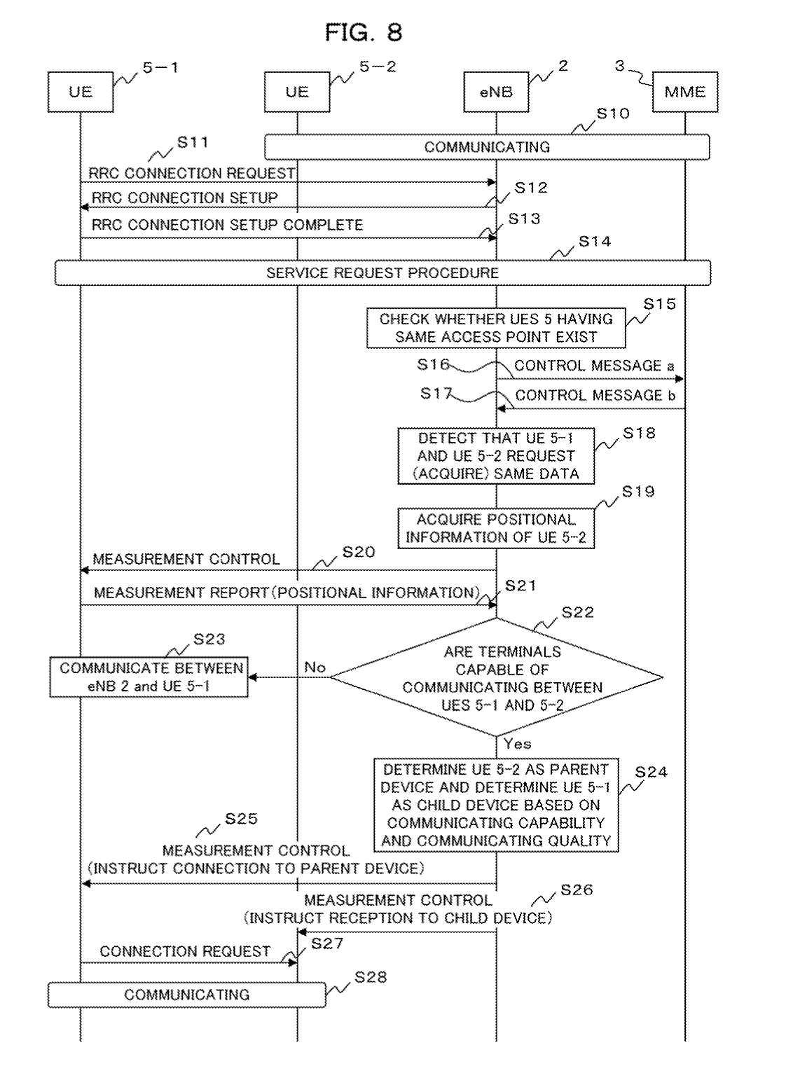

Here, a specific example of the control operation in the wireless communicating system 1 will be described with reference to FIG. 8.

As illustrated in FIG. 8, it is considered that the UE 5-2 is connected with the core network through the eNB 2 and is receiving the data (step S10).

In this case, when a call connection request (RRC (radio resource control) connection request) message is transmitted from the UE 5-1 under the eNB 2 to the eNB 2 (step S11), the eNB 2 returns a call connection setup (RRC connection setup) message to the UE 5-1 (step S12).

The UE 5-1 that receives the call connection setup (RRC connection setup) message from the eNB 2 transmits a call connection setup complete (RRC connection setup complete) message to the eNB 2 (step S13). By doing this, the call connection setup between the UE 5-1 and the eNB 2 is completed.

Next, the UE 5-1 performs a service request procedure for requesting data (service) to the eNB 2 (step S14). When the service request procedure is completed, the UE 5-1 performs a procedure for U-Plane data communicating setup.

In this case, it is considered that the UE 5-1, for example, requests the data same as the data which is obtained by the UE 5-2 to the eNB 2.

The eNB 2, for example, checks whether there are a plurality of UEs 5 having the same access point under the local station 2 based on information of the access point of the UE 5-1 received from the UE 5-1 in the procedure for U-Plane data communicating setup (step S15).

In the example illustrated in FIG. 8, since the UE 5-1 requests the same data as the data which is obtained by the UE 5-2, the eNB 2 detects that the plurality of UEs 5-1 and 5-2 having the same access point exist under the local station 2.

In this case, the eNB 2 transmits a control message a including identification information for identifying the UEs 5-1 and 5-2 to the MME 3 (step S16) and inquires the information concerning the UEs 5-1 and 5-2 to the MME 3. Further, as the identification information for identifying the UEs 5, for example, a TMSI (temporary mobile subscriber identity) or an IMSI (international mobile subscriber identity) is included.

When the MME 3 receives the control message a, the MME 3 searches information concerning the UEs 5-1 and 5-2 identified by the identification information included in the control message a from the storage unit 304 and generates a control message b including the information concerning the UEs 5-1 and 5-2 to be return to the eNB 2 (step S17). Further, the information concerning the UEs 5-1 and 5-2, for example, includes information concerning a communicating capability relating to a wireless communicating method (LTE or HSDPA (high speed downlink packet access) or a terminal-to-terminal communicating method (wireless LAN (local area network) or Bluetooth (registered trademark)), access point information such as an access point address or a port number of an access point, or obtained data information such as a name of an obtained data or a size of an obtained data.

The eNB 2 detects that the UE 5-1 and the UE 5-2 request or obtain the same data based on the contents of the control message b received from the MME 3 (step S18).

Next, the eNB 2 obtains positional information of the UE 5-2 based on positional information which has been received from the UE 5-2 (step S19), performs the measurement control/report procedure on the UE 5-1 (steps S20 and S21), and obtains the positional information of the UE 5-1.

Further, the eNB 2 determines whether the terminal-to-terminal communication between the UE 5-1 and the UE 5-2 is available without using the eNB 2 or the core network based on the obtained positional information and the information concerning the UEs 5-1 and 5-2 received from the MME 3 (step S22).

When it is determined that the terminal-to-terminal communication between the UE 5-1 and the UE 5-2 is not available (No route of step S22), the eNB 2 wirelessly transmits the data which is requested by the UE 5-1 directly from the eNB 2 (step S23).

In the meantime, when it is determined that the terminal-to-terminal communication between the UE 5-1 and the UE 5-2 is available (Yes route of step S22), the eNB 2 determines the UE 5-2 as a parent device and the UE 5-1 as a child device based on the communicating capability or the communication quality of the UEs 5-1 and 5-2 (step S24).

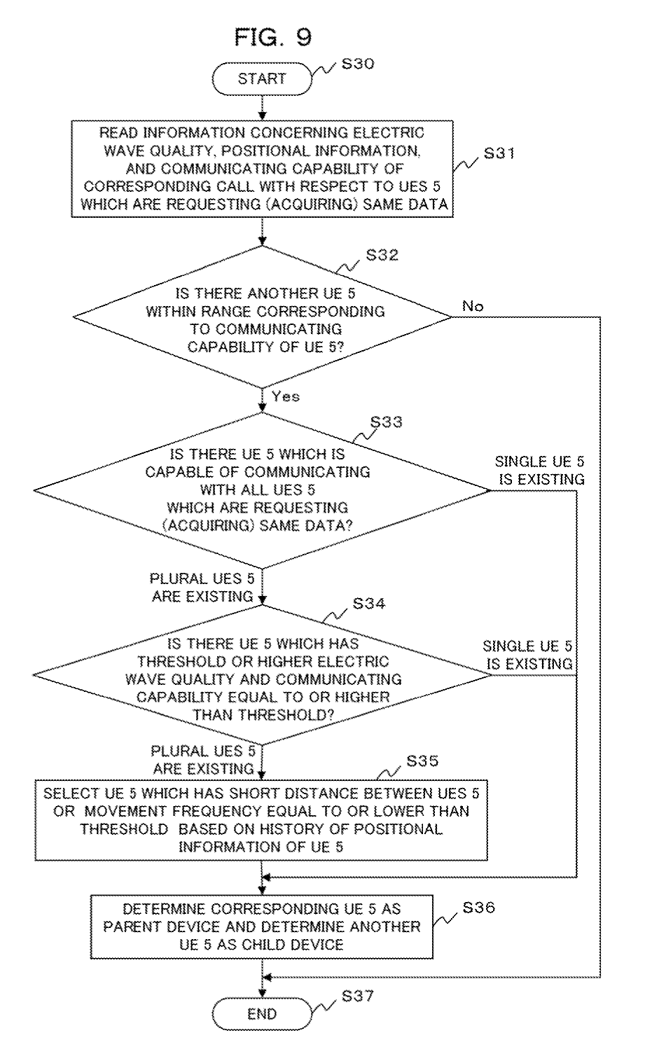

Here, a specific example of a method of determining the parent device and the child device will be described with reference to FIG. 9.

As illustrated in FIG. 9, as the processing of step S24 illustrated in FIG. 8 starts, when the determination processing of the parent device and the child device in the eNB 2 starts (step S30), the eNB 2 reads information concerning the electric wave quality, a position, or a communicating capability of the call of the plurality of UEs 5 that request or obtain the same data from the MME 3 (step S31). The information concerning the electric wave quality, for example, includes an FER (frame error rate), a BLER (block error rate), or Ec/No. Further, the information concerning the position, for example, includes positional information of the UEs 5 obtained by a GPS (global positioning system). Further, the information concerning the communicating capability, for example, includes a wireless communicating method (LTE or HSDPA) which is supported by the UEs 5 or a near field communicating method (wireless LAN or Bluetooth (registered trademark)).

Next, the eNB 2 determines whether another UE 5 exists in a range corresponding to the communicating capability of the UEs 5 with respect to every UE 5 of the plurality of UEs 5 that request or obtain the same data (step S32). For example, when an arbitrary UE 5 has a communicating capability which is capable of performing the terminal-to-terminal communication within a range of 10 m from the local station 5, the eNB 2 determines whether another UE 5 is present within a range of 10 m from the UEs 5.

When it is determined that another UE 5 is not present within the range corresponding to the communicating capability of the UEs 5, with respect to any UE 5 of the plurality of UEs 5 (No route of step S32), the eNB 2 determines that a UE 5 which is capable of terminal-to-terminal communicating is not present and completes the determining process (step S37).

In the meantime, when it is determined that another UE 5 is present within the range corresponding to the communicating capability of the UE 5, with respect to any one of the plurality of UEs 5 (Yes route of step S32), the eNB 2 determines that the UE 5 which is capable of terminal-to-terminal communicating is present, and then determines whether the terminal-to-terminal communication is available between all of the UEs 5 which request or obtain the same data (step S33).

Here, when it is determined that there is only one UE 5 which is capable of communicating with all UEs 5 which request or obtain the same data (“single UE is existing” route of step S33), the eNB 2 determines the corresponding UE 5 as a parent device and the other UEs 5 as a child device (step S36) and then completes the determining process (step S37). Further, when it is determined that there is no UE 5 which is capable of communicating with all UEs 5 which request or obtain the same data, the eNB 2 may determine a UE 5 which is capable of communicating with the most UEs 5 as a parent device and the other UEs 5 as a child device.

In the meantime, when it is determined that there are a plurality of UEs which are capable of communicating with all UEs 5 which request or obtain the same data (“plural UEs are existing” route of step S33), the eNB 2 determines whether there is a UE 5 whose electric wave quality or communicating capability is equal to or higher than a certain threshold, among the plurality of UEs 5 (step S34).

Here, when it is determined that there is only one UE 5 whose electric wave quality or communicating capability is equal to or higher than a certain threshold (“single UE is existing” route of step S34), the eNB 2 determines the corresponding UE 5 as a parent device and the other UEs 5 as a child device (step S36) and completes the determining process (step S37). Further, when it is determined that there is no UE 5 whose electric wave quality or communicating capability is equal to or higher than the certain threshold, the eNB 2 reduces the certain threshold and may repeat the processing of step S34 again.

In other words, the eNB 2 may select (determine) a parent device so as to maximize a quality of data received from the UE 5 as a parent device in the UE 5 as a child device based on the positional information and the communicating capability of the plurality of UEs 5.

In contrast, when it is determined that there are a plurality of UEs 5 whose electric wave quality or communicating capability is equal to or higher than a certain threshold (“plural UEs are existing” route of step S34), the eNB 2 determines a parent device and a child device so as to minimize the distance between the parent device and the child device or determines an arbitrary UE 5 whose movement frequency or the movement distance is equal to or smaller than other threshold as a parent device and the other UEs 5 as a child device based on the positional information of the plurality of UEs 5 (steps S35 and S36) and completes the determining process (step S37). By determining the UE 5 whose movement frequency or movement distance is small as the parent device, for example, it is possible to suppress the UEs 5 from being separated from each other so that the terminal-to-terminal communication is not available immediately after starting the communication. The eNB 2 may obtain the movement frequency or the movement distance of the UEs 5 from the movement history of the UEs 5.

Here, in the eNB 2, the movement history of the UEs 5 may be calculated, for example, by storing the time when the hand over is completed or the measurement report is received. The measurement report is a control message that notifies the result obtained by measuring the quality of a wireless section transmission channel by the UEs 5. The UEs 5 move and the communicating circumstantial environment is changed so that the electric wave quality is significantly varied. In contrast, when the UEs 5 do not move but stay at a fixed point, the electric wave quality may be changed a little bit by the external factor. However, the change in the electric wave quality is small as compared with the UEs 5 which move, so that the notification frequency of the measurement report is reduced as compared with the UEs 5 which move. Therefore, the eNB 2, for example, may estimate whether the UEs 5 move in a cell based on the notification frequency of the measurement report. Further, the movement of the UEs 5 between cells may be detected based on the hand over completion momentum.

As described above, when the determining process of the parent device and the child device is completed, the eNB 2 transmits information for connecting the UE 5-1 which is determined as the child device to the UE 5-2 which is determined as a parent device so as to be included in the measurement control message (step S25 of FIG. 8).

In the meantime, the eNB 2 transmits information for accepting the connection from the UE 5-1 which is determined as a child device to the UE 5-2 determined as a parent device so as to be included the measurement control message (step S26 of FIG. 8).

Further, the UE 5-1 as a child device requests the connection to the UE 5-2 as a parent device (step S27) and directly receives the data which is requested to the eNB 2 by the terminal-to-terminal communication from the UE 5-2 as a parent device (step S28).

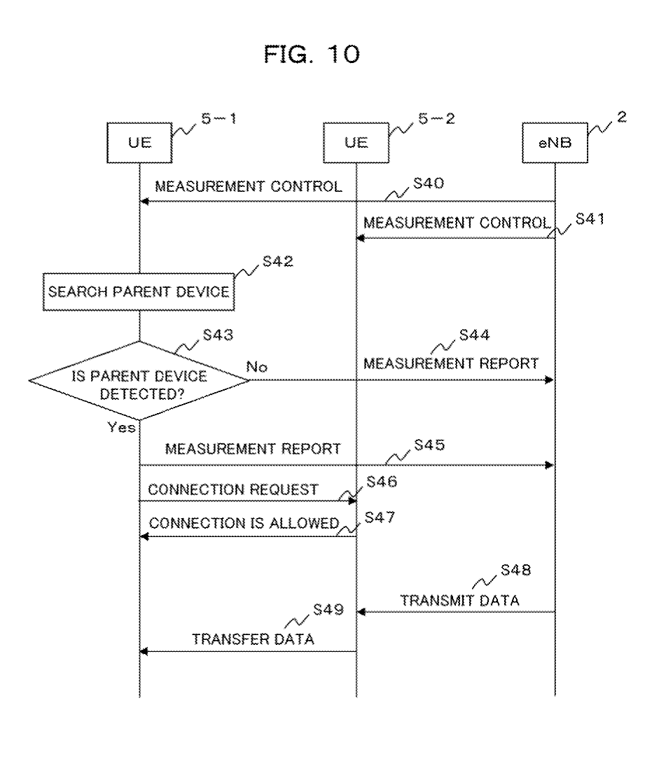

Here, a specific example of the terminal-to-terminal communication between the parent device and the child device will be described with reference to FIG. 10.

As illustrated in FIG. 10, first, the eNB 2 transmits the measurement control message including information for connecting the UE 5-1 as a child device to the UE 5-2 as a parent device (step S40). The measurement control message, for example, includes information concerning a connecting method between the parent device and the child device (wireless LAN or Bluetooth (registered trademark)), information for identifying the parent device (SSID (service set Identifier)) or information concerning an encryption scheme or a password. Further, the password is preferably a temporal password (one time password) which may be allocated from the eNB 2 in order to transfer data between the parent device and the child device in the light of a security.

Next, the eNB 2 transmits the measurement control message including information for receiving the connection request from the UE 5-1 as a child device to the UE 5-2 as a parent device (step S41). The measurement control message, for example, includes information concerning a connecting method between the parent device and the child device (wireless LAN or Bluetooth (registered trademark)), information for identifying the child device (TMSI or IMSI) or information concerning an encryption scheme or a password. Further, the password is preferably a temporal password (one time password) which may be allocated from the eNB 2 in order to transfer data between the parent device and the child device in the light of a security.

When the UE 5-1 as a child device receives the measurement control message including information for connecting to the UE 5-2 as a parent device from the eNB 2, the UE 5-1 searches a parent device based on the SSID included in the information (step S42) and determines whether the parent device is found (step S43).

When the parent device is not found (No route of step S43), the UE 5-1 as a child device transmits the measurement report message including the information, indicating that the connection to the UE 5-2 as a parent device is not available, to the eNB 2 (step S44).

In the meantime, when the parent device is found (Yes route of step S43), the UE 5-1 as a child device transmits a measurement report message including information, indicating that the connection to the UE 5-2 as a parent device is available, to the eNB 2 (step S45).

Further, the UE 5-1 as a child device transmits a connection request to the UE 5-2 as a parent device (step S46) and the UE 5-2 as a parent device determines whether the connection request transmitted from the UE 5-1 as a child device is proper based on the measurement control message including the information for receiving the connection request from the child device.

In the example illustrated in FIG. 10, it is determined that the connection request transmitted from the UE 5-1 as a child device is proper and the UE 5-2 as a parent device transmits a control message indicating the connection admission to the UE 5-1 as a child device (step S47).

The eNB 2 wirelessly transmits the data which is requested by the UEs 5-1 and 5-2 to the UE 5-2 as a parent device (step S48) and does not wirelessly transmit the data to the UE 5-1 as a child device.

The data is transferred from the UE 5-2 as a parent device to the UE 5-1 as a child device (step S49).

As described above, in this example, when the plurality of UEs 5 request the same data to the eNB 2, the eNB 2 selects an arbitrary parent device from the plurality of UEs 5 and allows only the parent device to communicate with the network side to obtain the data, but allows the other UEs 5 (child device) not to communicate with the network side but communicate with a parent device which has obtained the data to obtain the data.

By doing this, the communication volume between the network side and the UE 5 as a child device may be reduced and the resource usage amount of wireless communication line may be reduced. Further, the user may reduce the data communication volume of the wireless communication line or shorten the time for obtaining the data.

### [2] First Modified Embodiment

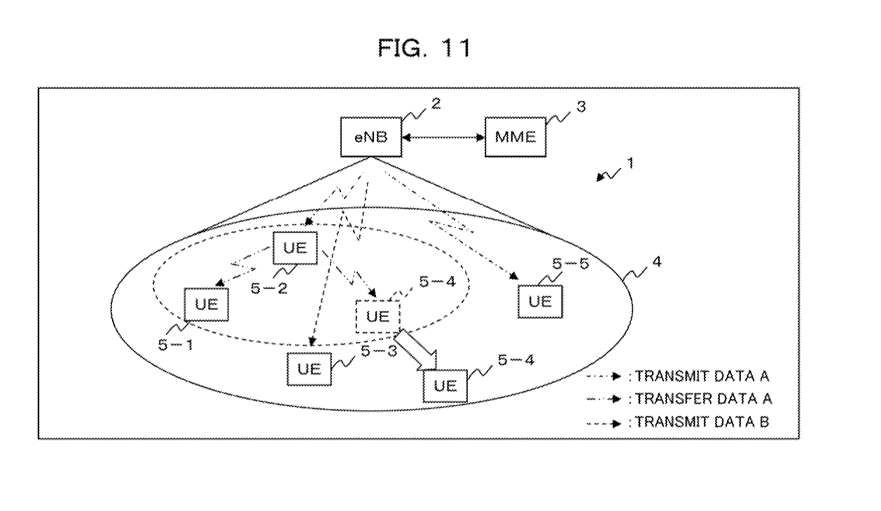

Further, as illustrated in FIG. 11, as a result of moving a UE 5-4 as a child device that directly receives data from the UE 5-2 as a parent device, the terminal-to-terminal communication with the UE 5-2 as a parent device is not available in some cases.

In this case, the UE 5-4 which may not perform the terminal-to-terminal communication with the UE 5-2 as a parent device may receive data which has been received from the UE 5-2, for example, through a network line which has been connected. Alternately, a new network line may be established and the data which has been received from the UE 5-2 by that time may be received through the line.

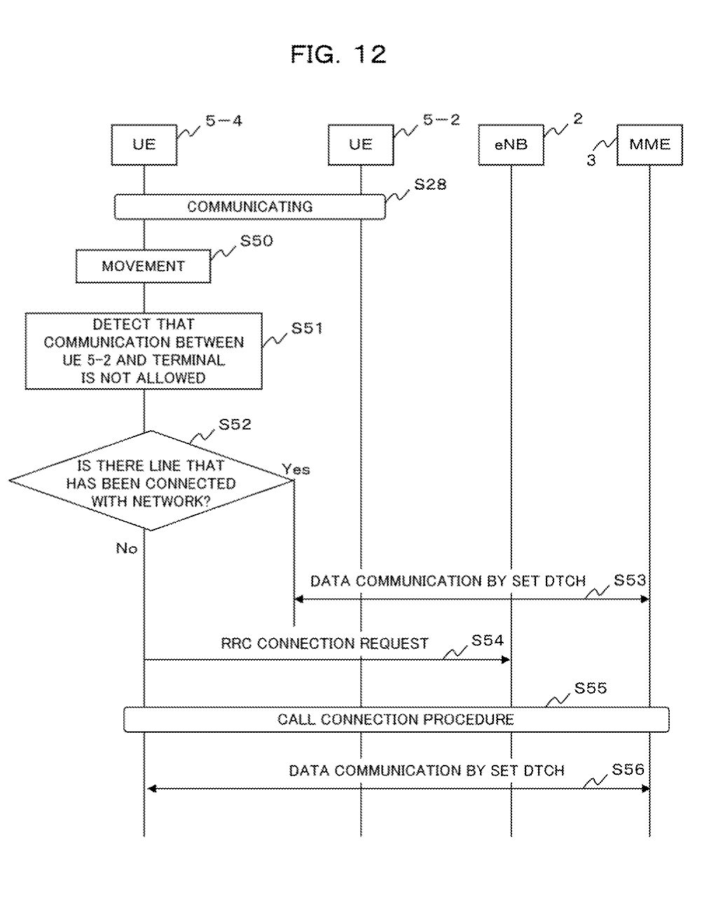

A specific example of a communicating control method is illustrated in FIG. 12.

As illustrated in FIG. 12, when the UE 5-4 as a child device directly receives the data which is requested to the eNB 2 from the UE 5-2 as a parent device by the terminal-to-terminal communication (step S28), it is considered that the UE 5-2 moves outside the range where the terminal-to-terminal communication is available (step S50).

By doing this, the UE 5-4 as a child device detects that the terminal-to-terminal communication with the UE 5-2 as a parent device is not available (step S51).

Here, the UE 5-4 as a child device determines whether a line (channel) which has been connected between the local station 5-4 and the eNB 2 is present (step S52). When it is determined that the connected channel is present (Yes route of step S52), the UE 5-4 receives the data which is received from the UE 5-2 as a parent device from the eNB 2 through a set dedicated traffic channel (DTCH) (step S53).

In the meantime, when it is determined that the connected channel is not present (No route of step S52), the UE 5-4 transmits a RRC connection request message to the eNB 2 (step S54) to perform call connecting procedure (step S55) and sets a call.

Further, the UE 5-4 receives the data which is received from the UE 5-2 as a parent device from the eNB 2 through the dedicated traffic channel (DTCH) set by the call connecting procedure (step S56).

As described above, according to this embodiment, as a result of moving the UE 5-4 as a child device, even though the terminal-to-terminal communication with the UE 5-2 as a parent device is not available, the data which has been received by that time is received from the network side to suppress the disconnection of the communication service.

### [3] Second Modified Embodiment

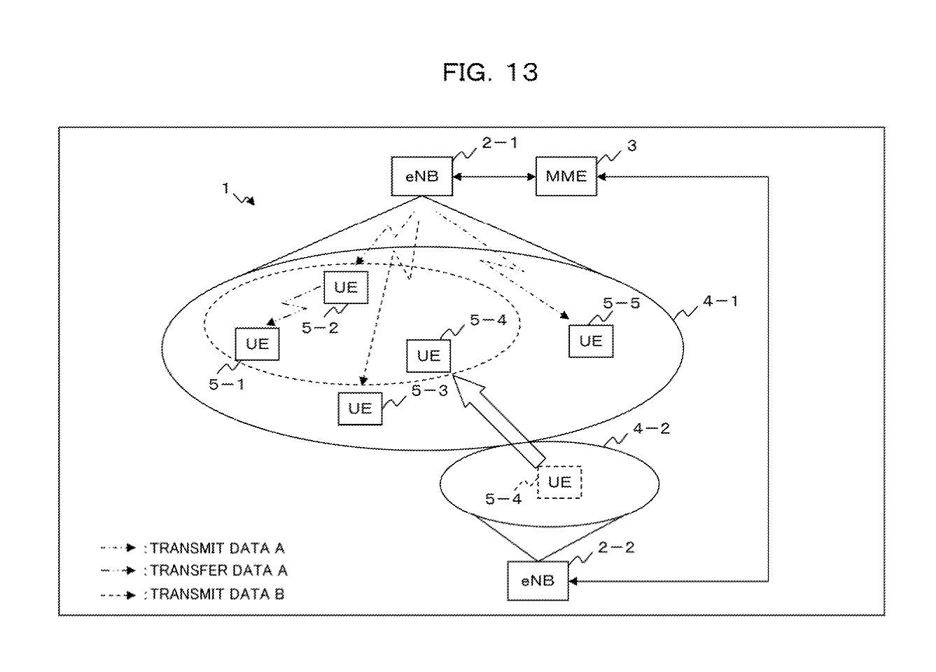

Further, as illustrated in FIG. 13, from a wireless area 4-2 of an eNB 2-2 outside the range of a wireless area 4-1 of an eNB 2-1, when the UE 5-4 that requests the same data moves in the range (see broken line ellipse of FIG. 13) where the terminal-to-terminal communication of the UE 5-2 serving as a parent device is available, the UE 5-4 is preferably treated as a child device.

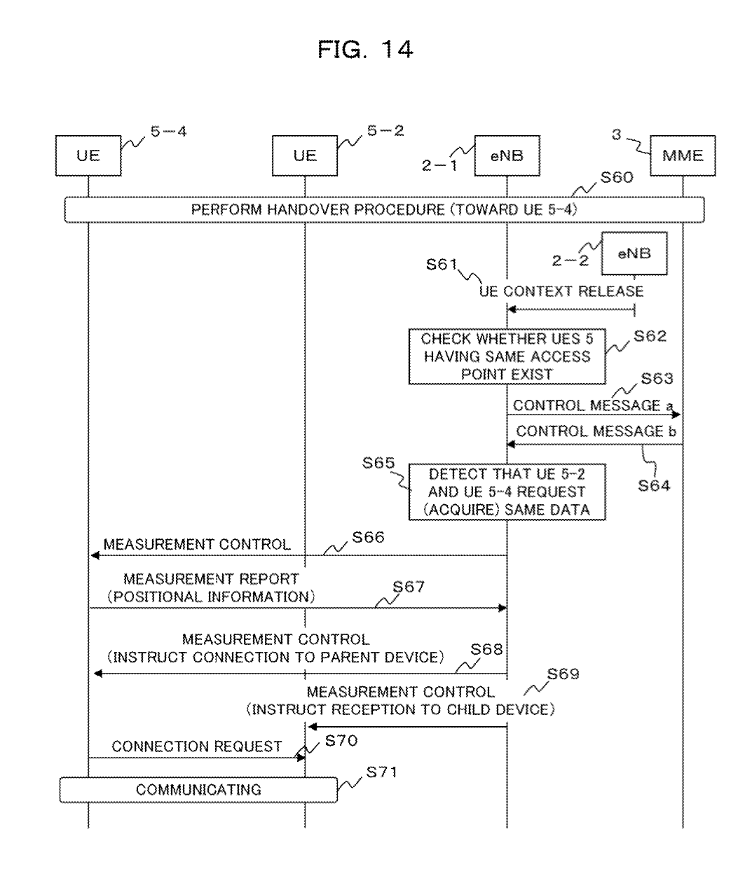

A specific example of a communicating control method according to this embodiment is illustrated in FIG. 14.

As illustrated in FIG. 14, when the UE 5-4 moves from the wireless area 4-2 of the eNB 2-2 into the wireless area 4-1 of the eNB 2-1, a handover procedure is performed (step S60).

In this case, from the eNB 2-2 which is a handover source, to the eNB 2-1 which is a handover destination, a UE context release message indicating that the resource allocation to the UE 5-4 is open is transmitted (step S61).

In this case, it is considered that the UE 5-4, for example, requests the same data as the data obtained by the UE 5-2 to the eNB 2.

For example, as the UE context release message is received, the eNB 2-1 checks whether a plurality of UEs 5 having the same access point are present under the local station 2-1 (step S62).

In the example illustrated in FIG. 13, since the UE 5-4 requests the same data as the data which is obtained by the UE 5-2, the eNB 2-1 detects that the plurality of UEs 5-2 and 5-4 having the same access point are present under the local station 2-1.

In this case, the eNB 2-1 transmits the control message a including identification information for identifying the UEs 5-2 and 5-4 to the MME 3 (step S63) and inquiries the information concerning the UEs 5-2 and 5-4 to the MME 3. Further, as the identification information for identifying the UE 5, for example, TMSI or IMSI is included.

When the MME 3 receives the control message a, the MME 3 searches information concerning the UEs 5-2 and 5-4 which are identified by the identification information included in the control message a from the storage unit 304 and generates a control message b including information concerning the UEs 5-2 and 5-4 to be returned to the eNB 2-1 (step S64). Further, the information concerning the UEs 5-2 and 5-4, for example, includes information concerning a communicating capability concerning a wireless communicating method (LTE or HSDPA) which is supported by the UEs 5 or a terminal-to-terminal communicating method (wireless LAN or Bluetooth (registered trademark)), or access point information such as an access point address or a port number of an access point, or obtained data information such as a name of an obtained data or a size of an obtained data.

The eNB 2-1 detects that the UE 5-4 and the UE 5-2 request or obtain the same data based on the contents of the control message b received from the MME 3 (step S65).

Next, the eNB 2-1 obtains positional information of the UE 5-2 based on positional information which has been received from the UE 5-2, performs the measurement control/report procedure on the UE 5-4 (steps S66 and S67), and obtains the positional information of the UE 5-4.

Further, the eNB 2-1 determines whether the terminal-to-terminal communication between the UE 5-2 and the UE 5-4 is available without using the eNB 2 or the core network based on the obtained positional information and the information concerning the UEs 5-2 and 5-4 received from the MME 3.

Herein, when it is determined that the terminal-to-terminal communication between the UE 5-2 and the UE 5-4 is not available, the eNB 2-1 wirelessly transmits the data which is requested by the UE 5-4 directly from the eNB 2-1.

In the meantime, when it is determined that the terminal-to-terminal communication between the UE 5-2 and the UE 5-4 is available, the eNB 2-1 determines the UE 5-2 as a parent device and the UE 5-4 as a child device based on the communicating capability or the communication quality of the UEs 5-2 and 5-4.

When the determining process of the parent device and the child device is completed, the eNB 2-1 transmits information for connecting to the UE 5-2 determined as a parent device to the UE 5-4 determined as a child device so as to be included in the measurement control message (step S68).

In the meantime, the eNB 2-1 transmits information for accepting the connection from the UE 5-4 determined as a child device to the UE 5-2 determined as a parent device so as to be included in the measurement control message (step S69).

Further, the UE 5-4 as a child device requests the connection to the UE 5-2 as a parent device (step S70) and directly receives the data requested to the eNB 2-1 from the UE 5-2 as a parent device by the terminal-to-terminal communication (step S71).

As described above, according to this example, even though the UE 5-4 that requests the same data as the data which is obtained by the UE 5-2 moves in the range of the UE 5-2 serving as a parent device which is capable of terminal-to-terminal communicating, the UE 5-4 may serve as a child device and the communication volume between the network side and the UE 5-4 as a child device may be reduced.

### [4] Third Modified Embodiment

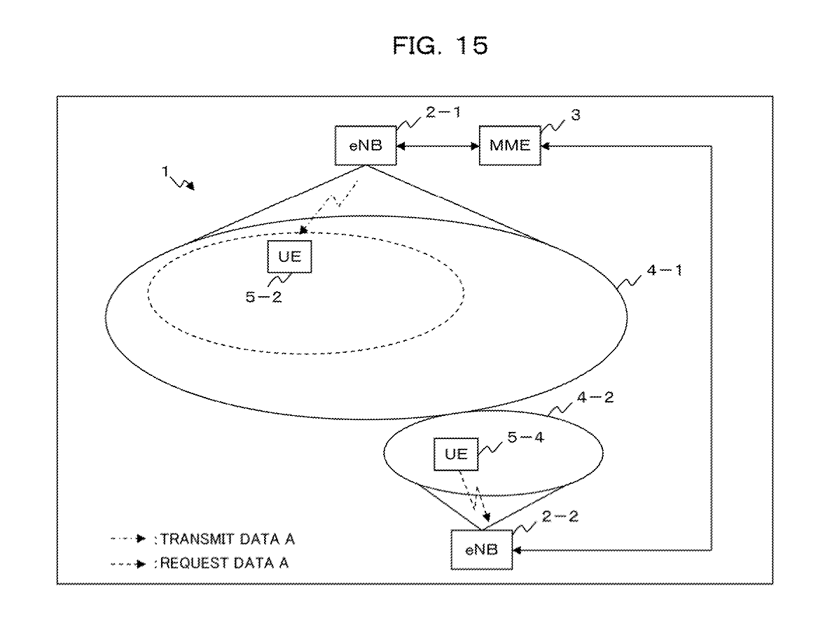

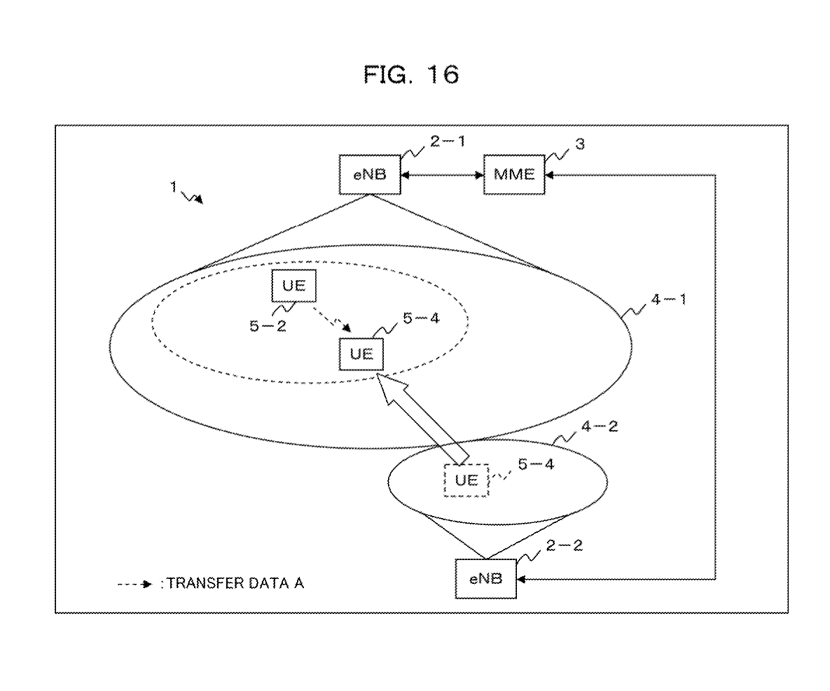

Further, as illustrated in FIG. 15, when the eNB 2-1 transmits data A to the UE 5-2 which is located in a range of the wireless area 4-1 (see a one-dot chain line arrow of FIG. 15) and the UE 5-4 which is located within a range of the wireless area 4-2 of the eNB 2-2 requests the data A to the eNB 2-2 during or after transmitting the data A (see a dashed line arrow of FIG. 15), as illustrated in FIG. 16, it is preferable to wait that the UE 5-4 moves in a range of the UE 5-2 which is capable of terminal-to-terminal communicating (see a dashed line ellipse of FIG. 16) and transmit the data A from the UE 5-2 as a parent device to the UE 5-4 as a child device by the terminal-to-terminal communication (see a dashed line arrow of FIG. 16).

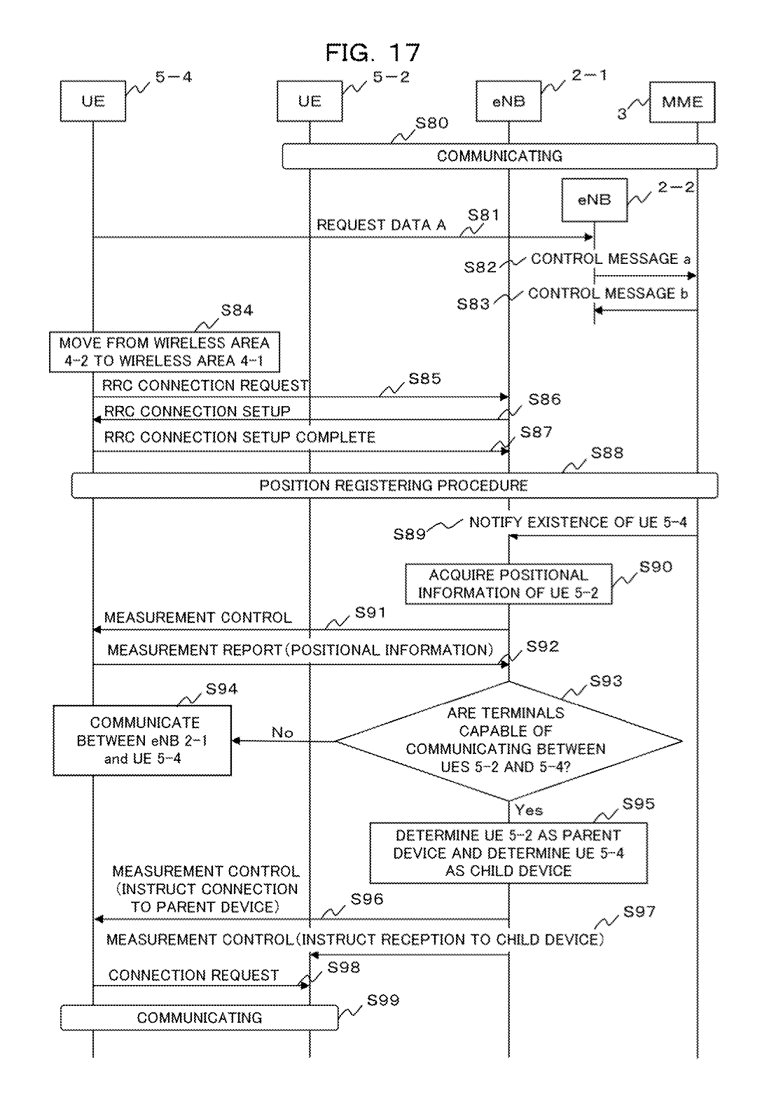

A specific example of a communicating control method according to this embodiment is illustrated in FIG. 17.

As illustrated in FIG. 17, it is considered that the UE 5-2 is connected to the core network through the eNB 2-1 to receive the data A (step S80).

In the meantime, it is considered that the UE 5-4 is connected to the core network through the eNB 2-2 to request data A (step S81).

In this case, the eNB 2-2 transmits the control message a including identification information for identifying the UE 5-4 to the MME 3 (step S82) and inquires whether there is a UE 5 which has obtained the data A to the MME 3. Further, as the identification information for identifying the UE 5, for example, TMSI (temporary mobile subscriber identify) or IMSI (international mobile subscriber identity) is included.

When the MME 3 receives the control message a, the MME 3 searches for information concerning the UE 5-4 which is identified by the identification information included in the control message a from the storage unit 304. Specifically, for example, the MME 3 determines whether there is a UE 5 which has obtained the same data A as the data A which is requested by the UE 5-4 and generates a control message b including information concerning the determination result to return the information to the eNB 2-2 (step S83). Further, the information concerning the determination result, for example, includes information concerning a communicating capability concerning a wireless communicating method (LTE or HSDPA (high-speed downlink packet access)) which is supported by the UE 5-2 which has obtained the same data A as the data A requested by the UE 5-4 or a terminal-to-terminal communicating method (wireless LAN (local area network) or Bluetooth (registered trademark)), or access point information such as an access point address or a port number of an access point, or obtained data information such as a name of an obtained data or a size of an obtained data.

Further, when the presence of the UE 5-2 which has obtained the same data A as the data A requested by the UE 5-4 is notified from the MME 3, the eNB 2-2 waits to transmit the data A to the UE 5-4. Further, when the waiting time exceeds a certain time, the eNB 2-2 may allow the UE 5-4 to start to transmit the data A or inquire a user of the UE 5-4 about a method of transmitting the data A (whether to wait to download the data by the terminal-to-terminal communication or release the waiting to download the data from the eNB 2-2).

Here, when the UE 5-4 moves from the wireless area 4-2 to the wireless area 4-1 (step S84), an RRC connection request message from the UE 5-4 is transmitted to the eNB 2-1 (step S85) and the eNB 2-1 returns the RRC connection setup message to the UE 5-4 (step S86).

The UE 5-4 which receives the RRC connection setup message from the eNB 2-1 transmits the RRC connection setup complete message to the eNB 2-1 (step S87). Accordingly, the RRC connection setup between the UE 5-4 and the eNB 2-1 is completed.

Next, the UE 5-4 performs a location registration procedure for registering the positional information of the local station 5-4 in the MME 3 on the eNB 2-1 (step S88). When the location registration procedure is completed, the UE 5-4 performs a procedure of setting communication of U-Plane data.

Here, by the location registration procedure, the MME 3 notifies the presence of the UE 5-4 which requests the data A to the eNB 2-1 (step S89).

Next, the eNB 2-1 obtains the positional information of the UE 5-2 based on the positional information which has been received from the UE 5-2 (step S90) and performs the measurement control/report procedure to the UE 5-4 (steps S91 and S92) to obtain the positional information of the UE 5-4.

Further, the eNB 2-1 determines whether the terminal-to-terminal communication is available between the UE 5-2 and the UE 5-4 without using the eNB 2 or the core network based on the obtained positional information and the information concerning the UE 5-2 received from the MME 3 (step S93).

When it is determined the terminal-to-terminal communication is not available between the UE 5-2 and the UE 5-4 (No route of step S93), the eNB 2-1, for example, wirelessly transmits the data A which is requested by the UE 5-4 directly from the eNB 2-1 (step S94). Further, the eNB 2-1, for example, may wait to transmit the data A which is requested by the UE 5-4 until the terminal-to-terminal communication is available between the UE 5-2 and the UE 5-4 by moving the UEs 5-2 and 5-4.

In contrast, when it is determined that the terminal-to-terminal communication is available between the UE 5-2 and the UE 5-4 (Yes route of step S93), the eNB 2-1 determines the UE 5-2 which has obtained the data A as a parent device and the UE 5-4 which requests the data A as a child device (step S95).

BY doing this, when the parent device and the child device are determined, the eNB 2-1 transmits information for connecting the UE 5-4 determined as a child device to the UE 5-2 determined as a parent device so as to be included in the measurement control message (step S96).

In the meantime, the eNB 2-1 transmits the information for accepting the connection from the UE 5-4 determined as a child device to the UE 5-2 determined as a parent device so as to be included in the measurement control message (step S97).

Further, the UE 5-4 as a child device requests the connection to the UE 5-2 as a parent device (step S98) and directly receives the data A requested to the eNB 2-2 from the UE 5-2 as a parent device by the terminal-to-terminal communication (step S99).

By doing this, even in this embodiment, it is possible to reduce the communication volume between the network side and the UE 5 as a child device and reduce the resource usage amount of the wireless communication line. Further, the user may reduce the data communication volume of the wireless communication line or shorten the data obtaining time.

In addition, this embodiment is specifically effective when the possibility that the UEs are gathered in a range which is capable of terminal-to-terminal communicating is relatively high. For example, it is preferable to group the users of the UE 5 as a family, friends, or an office of the user to apply this embodiment to the UEs 5 in the corresponding group. By doing this, data which is downloaded by any one of the UEs 5 in the group is transferred to the other UE 5 in the same group by the terminal-to-terminal communication, which may significantly reduce the communication volume of the wireless communicating system 1 at the network side. As a result, the user may save the communication cost at a data metered rate or shorten the data obtaining time.

Further, this embodiment is specifically effective when the data A is a data type (for example, software update file) which the request for the real-time property is comparatively weak.

### [5] Example of Hardware Configuration

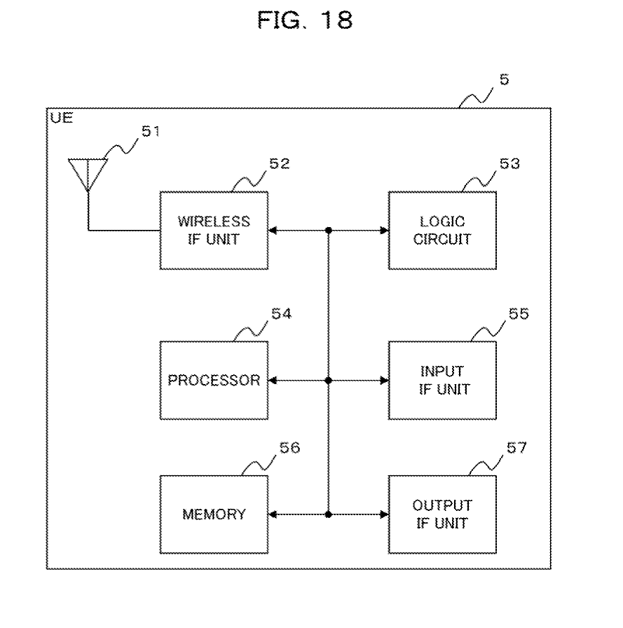

Here, an example of a hardware configuration of the UE 5 is illustrated in FIG. 18.

As illustrated in FIG. 18, the UE 5, illustratively, includes an antenna 51, a wireless interface unit (wireless IF unit) 52, a logic circuit 53, a processor 54, an input interface unit (input IF unit) 55, a memory 56, and an output interface unit (output IF unit) 57.

The wireless IF unit 52, for example, is an interface device that wirelessly communicates with the eNB2 through the antenna 51. The logic circuit 53 is an electronic circuit that performs logical operations, and for example, includes an LSI (large scale integration) or an FPGA (field programmable gate array). The processor 54 is a device that processes data, and for example, includes a CPU (central processing unit) or a DSP (digital signal processor). The input IF unit 55 is a device that performs inputting, and for example, includes a manipulating button or a microphone. The memory 56 is a device that stores data, and for example, includes a ROM (read only memory) or a RAM (random access memory). The output IF unit 57 is a device that performs outputting, and for example, includes a display or a speaker.

Further, the correspondence relationship between the configurations of the UE 5 illustrated in FIG. 2 and the configurations of the UE 5 illustrated in FIG. 18 is as follows.

The antenna 51 corresponds to, for example, the antennas 501 and 506, the wireless IF unit 52 corresponds to, for example, the first antenna duplexer 502, the first receiver 503, the first transmitter 504, the second antenna duplexer 507, the second receiver 508, and the second transmitter 509.

Further, the logic circuit 53, the processor 54, and the memory 56 correspond to, for example, the first baseband processor 505, the second baseband processor 510, and the controller 511, respectively.

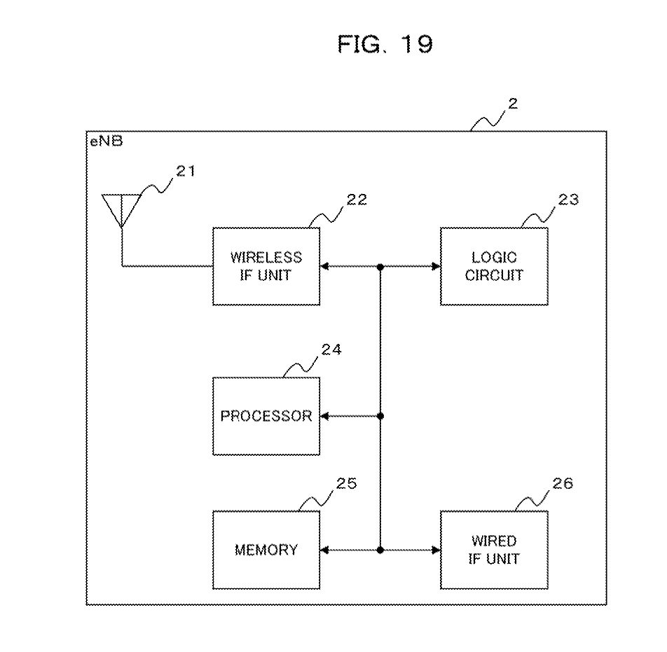

An example of a hardware configuration of the eNB 2 is illustrated in FIG. 19.

As illustrated in FIG. 19, the eNB 2, illustratively, includes an antenna 21, a wireless IF unit 22, a logic circuit 23, a processor 24, a memory 25, and a wired interface unit (wired IF unit) 26.

The wireless IF unit 22, for example, is an interface device that wirelessly communicates with the UE 5 through the antenna 21. The logic circuit 23 is an electronic circuit that performs logical operations, and for example, includes an LSI or an FPGA. The processor 24 is a device that processes data, and for example, includes a CPU or a DSP. The memory 25 is a device that stores data, and for example, includes a ROM or a RAM. The wired IF unit 26 is an interface device that performs wired communication with the MME3, another eNB or an external system which is connected to a network (what is called, back-haul network) of the wireless communicating system 1.

Further, the correspondence relationship between the configurations of the eNB 2 illustrated in FIG. 3 and the configurations of the eNB 2 illustrated in FIG. 19 is as follows.

The antenna 21 corresponds to, for example, the antenna 201, the wireless IF unit 22 corresponds to, for example, the antenna duplexer 202, the receiver 203, and the transmitter 204.

In addition, the logic circuit 23, the processor 24, and the memory 25 correspond to, for example, the baseband processor 205, the signal processor 206, and the controller 209, respectively.

Furthermore, the wired IF unit 26 corresponds to, for example, the network side transmitter 207 and the network side receiver 208.

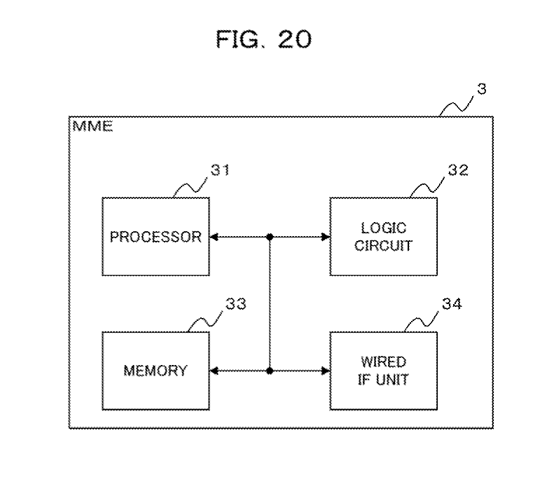

An example of a hardware configuration of the MME 3 is illustrated in FIG. 20.

As illustrated in FIG. 20, the MME 3, illustratively, includes a processor 31, a logic circuit 32, a memory 33, and a wired IF unit 34.

The processor 31 is a device that processes data, and for example, includes a CPU or a DSP. The logic circuit 32 is an electronic circuit that performs logical operations, and for example, includes an LSI or an FPGA. The memory 33 is a device that stores data, and for example, includes a ROM or a RAM. The wired IF unit 34 is an interface device that performs the wired communication with the eNB 2.

The correspondence relationship between the configurations of the MME 3 illustrated in FIG. 4 and the configurations of the MME 3 illustrated in FIG. 20 is as follows.

The wired IF unit 34 corresponds to, for example, the receiver 301 and the transmitter 306, and the processor 31, the logic circuit 32, and the memory 33 correspond to, for example, the message extracting unit 302, the message generator 305, the controller 303, and the storage unit 304, respectively.

### [6] Others

Further, the configurations of the wireless communicating system 1, the eNB 2, the MME 3, and the UE 5 in the above-described embodiments and modified embodiments may be selected if necessary and appropriately combined to be used. In other words, the configurations or the functions may be selected or appropriately combined to be used so as to demonstrate the functions of the invention.

For example, the information concerning the transmission data between the UE 5 as a parent device and the network side may be shared. By doing this, by the movement, the UE 5 which may not perform the terminal-to-terminal communication with the UE 5 as a parent device may resume to download the data which has been received from the UE 5-2 by that time through the connected network line or a newly established network line.

Further, by sharing the information concerning the transmission data between the UE 5 as a parent device and the network side, as illustrated in FIG. 13, even when the UE 5-4 that requests the same data moves from the wireless area 4-2 of the eNB 2-2 which is outside the range of the wireless area 4-1 of the eNB 2-1 into the range of the UE 5-2 serving as a parent device which is capable of terminal-to-terminal communicating (a broken line ellipse of FIG. 13), the UE 5-4 may resume to download the data which has been received from the network side by that time.

According to the above embodiments, it is possible to reduce the amount of the data communication in a wireless communicating system.

All examples and conditional language recited herein are intended for pedagogical purposes to aid the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control method of a wireless communicating system having a plurality of wireless terminals having an Ad-hoc communication function and a wireless base station which is capable of communicating with the plurality of wireless terminals, the control method comprising:
receiving data directly from the wireless base station by one wireless terminal, which requests the data to the wireless base station, among the plurality of wireless terminals; and
by at least one other wireless terminal, which requests the data to the wireless base station, among the plurality of wireless terminals, receiving the data from the one wireless terminal by use of the Ad-hoc communication function

2. The control method according to claim 1, further comprising:
detecting wireless terminals each of which requests the same data to the wireless base station, based on information concerning respective access points of the plurality of wireless terminals.

3. The control method according to claim 1, further comprising:
selecting, based on positional information of the plurality of wireless terminals, the one wireless terminal so as to maximize the number of the other wireless terminals being located in a range where the Ad-hoc communication function of the one wireless terminal is provided.

4. The control method according to claim 1, further comprising:
selecting, based on positional information and communicating capability of the plurality of wireless terminals, the one wireless terminal so as to maximize a quality of the data which is received from the one wireless terminal at the at least one other wireless terminal.

5. The control method according to claim 1, further comprising:
receiving the data directly from the wireless base station by the at least one other wireless terminal being located outside a range where the Ad-hoc communication function of the one wireless terminal is provided.

6. The control method according to claim 1, further comprising:
receiving the data directly from the wireless base station by the at least one other wireless terminal incapable of communicating with the one wireless terminal by use of the Ad-hoc communication function.

7. The control method according to claim 1, further comprising:
receiving the data from the one wireless terminal by use of the Ad-hoc communication function by a wireless terminal which requests the same data as the data to another wireless base station after the wireless terminal has moved into a range where the Ad-hoc communication function of the one wireless terminal is provided.

8. A wireless base station of a wireless communicating system having a plurality of wireless terminals having an Ad-hoc communication function and a wireless base station which is capable of communicating with the plurality of wireless terminals, the wireless base station comprising:
a receiver that receives a request of data from the plurality of wireless terminals; and
a controller that controls one wireless terminal, which requests the data to the wireless base station, among the plurality of wireless terminals to directly receive the data from the wireless base station, and controls at least one other wireless terminal, which requests the data to the wireless base station, among the plurality of wireless terminals to receive the data from the one wireless terminal by use of the Ad-hoc communication function of the one wireless terminal.

9. A wireless terminal of a wireless communicating system having a plurality of wireless terminals having an Ad-hoc communication function and a wireless base station which is capable of communicating with the plurality of wireless terminals, the wireless terminal comprising:
a base station side transmitter that transmits a data request to the wireless base station;
a base station side receiver that directly receives the data corresponding to the request transmitted from the base station side transmitter from the wireless base station; and
a terminal side transmitter that directly transmits the data received by the base station side receiver to at least one other wireless terminal by use of the Ad-hoc communication function.

10. A wireless terminal of a wireless communicating system having a plurality of wireless terminals having an Ad-hoc communication function and a wireless base station which is capable of communicating with the plurality of wireless terminals, the wireless terminal comprising:
a base station side transmitter that transmits a data request to the wireless base station; and
a terminal side receiver that directly receives the data corresponding to the request transmitted from the base station side transmitter from another wireless terminal by use of the Ad-hoc communication function.

11. A wireless communicating system having a plurality of wireless terminals having an Ad-hoc communication function and a wireless base station which is capable of communicating with the plurality of wireless terminals, wherein the wireless base station includes:
a receiver that receives a request of data from the plurality of wireless terminals; and
a controller that controls one wireless terminal, which requests the data to the wireless base station, among the plurality of wireless terminals to directly receive the data from the wireless base station, and controls at least one other wireless terminal, which requests the data to the wireless base station, among the plurality of wireless terminals to receive the data from the one wireless terminal by use of the Ad-hoc communication function of the one wireless terminal,
the one wireless terminal includes:
a base station side receiver that directly receives the data from the wireless base station; and
a terminal side transmitter that directly transmits the data received by the base station side receiver to the at least one other wireless terminal by use of the Ad-hoc communication function; and
the at least one other wireless terminal includes:
a terminal side receiver that directly receives the data from the one wireless terminal by use of the Ad-hoc communication function.
